(19) United States
(12) Patent Application Publication
(10) Pub. No.: US 2022/0206404 A1
(43) Pub. Date: Jun. 30, 2022

(54) HUMAN BODY-SAFE EXTERNAL ADDITIVE FOR TONER AND TONER MANUFACTURED USING SAME

(71) Applicant: SUKGYUNG AT CO., LTD., Ansan-si, Gyeonggi-do (KR)

(72) Inventors: Hyung Jun LIM, Anyang-si, Gyeonggi-do (KR); Young Chul YOU, Ansan-si, Gyeonggi-do (KR); O Sung KWON, Gunpo-si, Gyeonggi-do (KR); Jin Seop KIM, Goyang-si, Gyeonggi-do (KR); Sang Gon KIM, Seoul (KR); Eun Young SONG, Incheon (KR); So Yeon LEE, Ansan-si, Gyeonggi-do (KR); Yong Gu YOO, Seoul (KR); Hyeon Seok CHOI, Ansan-si, Gyeonggi-do (KR)

(73) Assignee: SUKGYUNG AT CO., LTD., Ansan-si, Gyeonggi-do (KR)

(21) Appl. No.: 17/614,504

(22) PCT Filed: Apr. 16, 2020
(86) PCT No.: PCT/KR2020/005093

§ 371 Date: Nov. 26, 2021

(30) Foreign Application Priority Data
May 29, 2019 (KR) 10-2019-0062963

(51) Int. Cl. G03G 9/097; G03G 9/08

(52) U.S. Cl. CPC G03G 9/09708; G03G 9/0819; G03G 9/09716; G03G 9/0821; G03G 9/0827

(57) ABSTRACT

The present invention provides an external additive for toner, selected from the group consisting of tin oxide fine particles, complex tin oxide fine particles, and a mixture of the same fine particles, wherein the fine particles are (−) charged fine particles having an energy band gap of 3.2 to 3.6 eV, an electronegativity value (χ) of 15 to 18, and a Blow-Off charge amount (uC/g) of −100 to −150. The external additive for toner of the present invention can: replace nano-sized titanium dioxide which has been conventionally used as an external additive for toner; guarantee general consumers using image devices as well as workers in the image industry safety from the harmful influences that may be generated upon exposure to the nano-sized titanium dioxide detached from the surface of a toner in use; and be safe for the human body.

### TECHNICAL FIELD

The present invention relates to an eco-friendly external additive for toner.

### BACKGROUND ART

Recently, according to the high performance and network supply of personal computers, high-definition, the improvement of productivity and high reliability are required for digital color copy machines and printers as the output printers of an information network system, and as an extension, market is gradually growing to on-demand printing. In addition, it is facing the issues of warming and issues of the exhaustion of energy and resources, and contribution to society including corporate responsibility is required for reaching sustainable communities, and the reduction of loads to the environment by resources and energy is required irrespective during manufacturing or during using.

In certain circumstances, the reduction of a particle diameter, the reduction of particle size distribution and vivid color development, to mainly achieve high definition, installation at low temperature for the reduction of consumption energy and the improvement of productivity, or the like are required for toner.

According to such a reduction of the particle diameter of the toner, the size of an external additive for toner, such as silicon dioxide, titanium dioxide, aluminum oxide and zinc oxide is gradually reduced, and the amount used of such external additive also increases gradually. Accordingly, general consumers as well as workers in related industries might be adversely affected by the use of titanium dioxide with a nano size, which has a controversial issue over the harmfulness.

### PRIOR ART DOCUMENTS

### Non-Patent Documents

(Non-patent document 1) 1. “Spotlighting CLH report for TiO2: Nano-safety perspective” Chemical Engineering Journal Vol. 340, 15 May 2018, Pages 192-195
(Non-patent document 2) 2. “Titanium dioxide in our everyday life; is it safe” Radiol Oncol 2011; 45(4): 227-247

### DISCLOSURE OF THE INVENTION

### Technical Problem

Currently, in image material industries, titanium dioxide (TiO₂) with a nano size is used among inorganic oxides coated at the surface of an image material, particularly, toner, and used for the purpose of performing the function as an external additive. There are relevant documents reporting that such titanium dioxide particles with a nano size are coated at the surface of the toner, and the titanium dioxide particles with a nano size detached from the surface of the toner according to the operation of a copy machine or a laser printer, adversely affect the human body, and papers relating thereto have been reported in succession.

Generally, as the inorganic oxide mainly used as an external additive at the surface of toner includes silicon oxide (SiO₂), titanium oxide (TiO₂), aluminum oxide (Al₂O₃), barium titanium oxide (BaTiO₃), zinc oxide (ZnO), or the like. However, practical inorganic oxides widely used as the external additive during manufacturing the toner may be silicon oxide (SiO₂), titanium oxide (TiO₂), and aluminum oxide (Al₂O₃). Among the above-described external additives, “titanium dioxide (TiO₂) with a nano size” is referred to as an external additive which may adversely affect the human body.

On the case where the titanium dioxide (TiO₂) nano-size particles are detached by the friction between coated toner particles or by the friction with a brush or the like in a copy machine or a laser printer, the researchers of the present invention conducted example experiments on the hazard warning of the adverse effects to the human body by the influences of titanium dioxide nano particles detached, studied on materials which may replace the role of the titanium dioxide particles at the toner, and invented a replaceable material which may replace the titanium dioxide nanoparticles.

That is, it was judged that the adverse effects to the human body could be fundamentally prevented by coating tin(IV) oxide nanoparticles and tin oxide-based nanoparticles, having almost similar electronegativity of metal ions as that of Ti⁻⁴ ion, Blow-Off charge amount (uC/g) of (−) charge, and the amount thereof of −100 to −150.

Accordingly, the researchers of the present invention intended to synthesize tin(IV) oxide and tin(IV) oxide-based nanoparticles, and tried to coat toner with the nanoparticles, thereby replacing titanium dioxide nano-size particles.

### Technical Solution

An external additive for toner of the present invention is an external additive for toner selected from the group consisting of tin oxide fine particles represented by General Formula of SnaOb (where, “Sn” is tin, “O” is oxygen, and 1.000≤a/b≤2.000 is satisfied), complex tin oxide fine particles represented by General Formula of MxSnyOz (where, M is one or more elements selected from H, an alkali metal, an alkaline earth metal, a rare earth element, Ca, Mg, Sr, Ba, Zr, Ti, Cr, Mn, Fe, Ru, Co, Rh, Ir, Ni, and In, Sn is tin, O is oxygen, 0.001≤x/y≤1 is satisfied, and 1.000≤z/y≤2.000 is satisfied), and a mixture of the fine particles.

The fine particles are characterized in being (−) charged fine particles having an energy band gap of 3.2 to 3.6 eV, an electronegativity value (x) of 15 to 18, and a Blow-Off charge amount (uC/g) of −100 to −150.

A diameter of primary particles of the fine particles is characterized in being 1 nm or more to 200 nm or less.

A size of secondary an aggregate that is an aggregate of the primary particles is characterized in being 10 μm or less.

A specific surface area of the tin oxide and the complex tin oxide fine particles has a value of 5 to 200 m²/g.

In addition, the fine particles are characterized in having a composition ratio represented by General Formula of SnaOb (where, “Sn” is tin, “O” is oxygen, and 1.000≤a/b≤2.000 is satisfied).

The complex tin oxide fine particles represented by General Formula of MxSnyOz is characterized in having any one or more structures among a tetragonal structure, a cubic structure and a rutile crystalline structure. Here, element M is characterized in being selected from the group consisting of Na, K, Cs, Mg, Ca, Sr, Ba, Fe, Sb, Al, In, Ti, and Zr.

Meanwhile, the present invention provides an external additive for toner, characterized in that surface of tin oxide fine particles and complex tin oxide fine particles having a size of primary particles of 1 nm to 200 nm is coated with a hydrophobic material showing hydrophobic function.

The surface of the tin oxide fine particles and the complex tin oxide fine particles is characterized in being treated and coated with a surface treating agent having General Formulae below.

(Y)m-Si—(X)n [Si: silicon, (Y+X=4)]

(Y)m-Ti—(X)n, [Ti: titanium, (Y+X=4)]

(Y)m-Zr—(X)n, [Zr: zirconium, (Y+X=4)]

(Y)m-Al—(X)n [Al: aluminum, (Y+Z=3)]

Y: an alkyl group, or a phenyl group, and

X: an alkoxy group, chloride, bromide, or fluoride.

Here, the content of the surface treating agent treated at the surface of the tin oxide fine particles and the complex tin oxide fine particles is characterized in being 0.1 to 50 wt % of the tin oxide fine particles.

Meanwhile, the present invention provides an external additive for toner, characterized in that surface of toner particles having an average particle diameter of 3 to 8 μm is coated with tin oxide and complex tin oxide fine particles having hydrophobicity within a range below.

Tin oxide/toner particles=0.01 to 1 (weight ratio).

### Advantageous Effects

There is voluntary movement in image industries on suppressing the use of “titanium dioxide (TiO2) having a nano size”, which is highly likely to have adverse influences on the human body, and as a countermeasure thereon, the present applicant attained an opportunity of developing toner securing safety by developing and using “tin(IV) oxide having a nano size”, which does not adversely influence on the human body. In conclusion, because the “titanium dioxide (TiO₂) having a nano size”, which is used as an external additive in toner industries, is not used, but aluminum(III) oxide-tin(IV) oxide complex oxide nano-size particles are used, the safety of workers in a manufacturer for manufacturing toner in the toner industry and general consumers using a copy machine or a laser printer, which uses image materials, particularly toner as consuming materials, could be guaranteed.

The titanium dioxide nano-size particles used as the external additive of an image material, particularly, toner, receive attention as a factor of harmfulness to the human body, the possibility of harmful exposure of general consumers, which could be induced by the detachment of titanium dioxide nano-size particles, which may be generated from a printing machine using toner as a consuming product, such as a copy machine and a laser printer, could be fundamentally blocked, and the health of general consumers and the safety and health of workers in toner-related industries could be maintained.

### BRIEF DESCRIPTION OF THE DRAWINGS

FIG. 1 shows TEM data of tin oxide nanoparticles.

FIG. 2 shows FE-SEM data of tin oxide fine particles used as an external additive for toner.

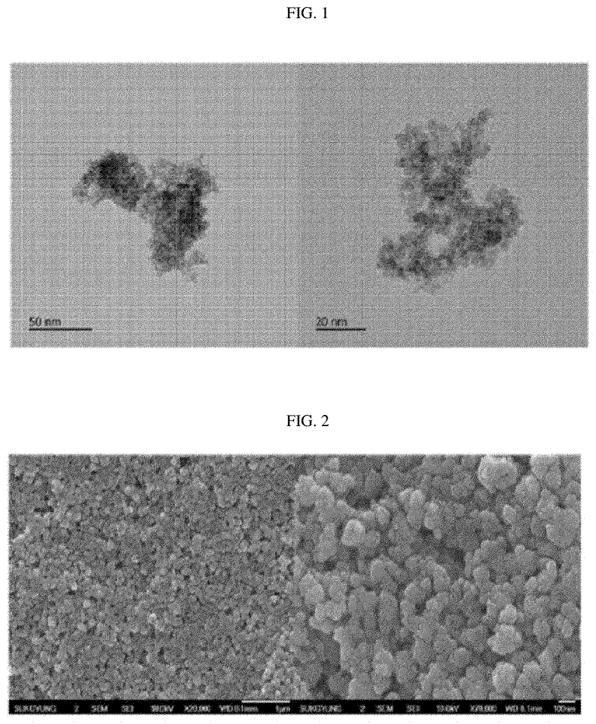

### MODE FOR CARRYING OUT THE INVENTION

Hereinafter, the synthesis of tin(IV) oxide and tin(IV) oxide-based nano-size particles will be explained in more detail. However, the contents of the present invention are not limited only to the explanation in the detailed description.

Generally, as the raw material of tin oxide, used for the synthesis of tin oxide fine particles and complex tin oxide fine particles, sodium stannate (Na₂SNO₃), potassium stannate (K₂SnO₃), tin(II) chloride, tin(IV) chloride, tin hydroxide (Sn(OH)₂), tin hydroxide (Sn(OH)₄), tin fluoride (SnF₂), tin(II) dimethoxide, tin(II) diethoxide, tin(II) diethoxide, tin(II) dipropoxide, tin(IV) tetramethoxide, tin(IV) tetraethoxide, tin(IV) tetrapropoxide, or the like may be mainly used, and as the raw material of complex tin oxide, tin compounds such as sodium stannate (Na₂SNO₃), potassium stannate (K₂SnO₃), tin(II) chloride, tin(IV) chloride, tin hydroxide (Sn(OH)₂), tin hydroxide (Sn(OH)₄), tin fluoride (SnF₂), tin(II) dimethoxide, tin(II) diethoxide, tin(II) diethoxide, tin(II) dipropoxide, tin(IV) tetramethoxide, tin(IV) tetraethoxide, and tin(IV) tetrapropoxide, aluminum compounds represented by sodium aluminate (NaAlO₂), aluminum chloride (AlCl₃), aluminum nitrate (Al(NO₃)₃), aluminum acetate, aluminum methoxide, aluminum ethoxide, aluminum propoxide, and aluminum isopropoxide, calcium compounds such as calcium chloride, calcium nitrate, calcium hydroxide, calcium methoxide, and calcium ethoxide, cesium compounds such as cesium chloride, cesium nitrate, cesium hydroxide, cesium fluoride, cesium methoxide, cesium ethoxide, and a cesium metal, magnesium compounds such as magnesium chloride, magnesium nitrate, magnesium hydroxide, magnesium methoxide, and magnesium ethoxide, strontium compounds such as strontium chloride, strontium nitrate, strontium hydroxide, strontium fluoride, strontium methoxide, and strontium ethoxide, barium compounds such as barium chloride, barium nitrate, barium hydroxide, barium fluoride, barium methoxide, and barium ethoxide, indium compounds such as indium chloride, indium nitrate, indium hydroxide, indium fluoride, indium methoxide, indium ethoxide, indium propoxide, and indium isopropoxide, antimony compounds such as antimony chloride, antimony nitrate, antimony hydroxide, antimony fluoride, antimony methoxide, and antimony ethoxide, iron compounds such as iron(II) chloride, iron(III) chloride, iron(II) sulfate, iron(II) nitrate, iron(III) nitrate, iron(II) hydroxide, iron(III) hydroxide, iron(II) fluoride, iron(III) fluoride, iron methoxide, and iron ethoxide, titanium compounds such as titanium(III) chloride, titanium(IV) chloride, titanium oxychloride (TiOCl₂), titanium methoxide, titanium ethoxide, titanium propoxide, and titanium isopropoxide, zirconium compounds such as zirconium(IV) chloride, zirconium oxychloride (ZrOCl₂), zirconium oxynitrate (ZrO(NO₃)₂), zirconium methoxide, zirconium ethoxide, zirconium propoxide, zirconium isopropoxide, zirconium butoxide, and zirconium isobutoxide, or the like may be used.

Tin oxide fine particles and the complex tin oxide fine particles may be prepared using such raw materials through a hydrolysis process and a hydrothermal process, and then, the fine particles may be dried by a freeze drying method, a vacuum drying method, a spray drying method, or the like to minimize the aggregation of such fine particles. And hydrophobic tin oxide fine particles and hydrophobic complex tin oxide fine particles treated with a surface treating agent represented by General Formula of (Y)m-Si—(X)n, (Y)m-Ti—(X)n, (Y)m-Zr—(X)n, or (Y)—Al—(X)n may be prepared to provide the surface of the fine particles thus obtained with hydrophobicity.

In this case, as an organic compound surface treating agent used as the surface treating agent may include silane coupling compounds such as hexamethyldisilazane, hexadecyltrimethoxysilane, hexadecyltriethoxysilane, hexadecyltrichlorosilane, hexadecylmethyldimethoxysilane, hexadecylmethyldiethoxysilane, hexadecylmethyldichlorosilane, hexadecyldimethylmethoxysilane, hexadecyldimethylethoxysilane, hexadecyldimethylchlorosilane, dodecyltrimethoxysilane, dodecyltriethoxysilane, dodecyltrichlorosilane, dodecyldimethyldimethoxysilane, dodecyldimethyldiethoxysilane, dodecyldimethylchlorosilane, decyltrimethoxysilane, decyltriethoxysilane, decyltrichlorosilane, decylmethyldimethoxysilane, decylmethyldiethoxysilane, decylmethyldichlorosilane, decyldimethylmethoxysilane, decyldimethylethoxysilane, decyldimethylchlorosilane, dimethyldimethoxysilane, dimethyldiethoxysilane, dimethyldichlorosilane, trimethylmethoxysilane, trimethylethoxysilane, and trimethylchlorosilane, titanium coupling compounds such as hexadecyltrimethoxytitanium, hexadecyltriethoxytitanium, hexadecyltrichlorotitanium, hexadecylmethyldimethoxytitanium, hexadecylmethyldiethoxytitanium, hexadecylmethyldichlorotitanium, hexadecyldimethylmethoxytitanium, hexadecyldimethylethoxytitanium, hexadecyldimethylchlorotitanium, dodecyltrimethoxytitanium, dodecyltriethoxytitanium, dodecyltrichlorotitanium, dodecyldimethyldimethoxytitanium, dodecyldimethyldiethoxytitanium, dodecyldimethylchlorotitanium, decyltrimethoxytitanium, decyltriethoxytitanium, decyltrichlorotitanium, decylmethyldimethoxytitanium, decylmethyldiethoxytitanium, decylmethyldichlorotitanium, decyldimethylmethoxytitanium, decyldimethylethoxytitanium, decyldimethylchlorotitanium, dimethyldimethoxytitanium, dimethyldiethoxytitanium, dimethyldichlorotitanium, trimethylmethoxytitanium, trimethylethoxytitanium, and trimethylchlorotitanium, zirconium compounds such as hexadecyltrimethoxyzirconium, hexadecyltriethoxyzirconium, hexadecyltrichlorozirconium, hexadecylmethyldimethoxyzirconium, hexadecylmethyldiethoxyzirconium, hexadecylmethyldichlorozirconium, hexadecyldimethylmethoxyzirconium, hexadecyldimethylethoxyzirconium, hexadecyldimethylchlorozirconium, dodecyltrimethoxyzirconium, dodecyltriethoxyzirconium, dodecyltrichlorozirconium, dodecyldimethyldimethoxyzirconium, dodecyldimethyldiethoxyzirconium, dodecyldimethylchlorozirconium, decyltrimethoxyzirconium, decyltriethoxyzirconium, decyltrichlorozirconium, decylmethyldimethoxyzirconium, decylmethyldiethoxyzirconium, decylmethyldichlorozirconium, decyldimethylmethoxyzirconium, decyldimethylethoxyzirconium, decyldimethylchlorozirconium, dimethyldimethoxyzirconium, dimethyldiethoxyzirconium, dimethyldichlorozirconium, trimethylmethoxyzirconium, trimethylethoxyzirconium, and trimethylchlorozirconium, aluminum compounds such as hexadecyldimethoxyaluminum, hexadecyldiethoxyaluminum, hexadecyldichloroaluminum, hexadecylmethylmethoxyaluminum, hexadecylmethylethoxyaluminum, hexadecylmethylchloroaluminum, hexadecyldimethoxyaluminum, hexadecyldiethoxyaluminum, hexadecyldichloroaluminum, dodecyldimethoxyaluminum, dodecyldiethoxyaluminum, dodecyldichloroaluminum, dodecylmethylmethoxyaluminum, dodecylmethylethoxyaluminum, dodecylmethylchloroaluminum, decyldimethoxyaluminum, decyldiethoxyaluminum, decyldichloroaluminum, decylmethylmethoxyaluminum, decylmethylethoxyaluminum, decylmethylchloroaluminum, decylmethylmethoxyaluminum, decylmethylethoxyaluminum, decylmethylchloroaluminum, dimethylmethoxyaluminum, dimethylethoxyaluminum, and dimethylchloroaluminum, or the like.

### Example

1. Synthesis of Tin(IV) Oxide Nano-Size Particles and Hydrophobic Coating

(1) 1 mol/L of sodium stannate (Na₂SnO₃) was weighed, and a sodium stannate (Na₂SnO₃) powder was slowly injected to pure water and dissolved well using a stirrer.

(2) To the sodium stannate solution obtained in (1), 1 mol/L of nitric acid (HNO₃) prepared in advance was slowly injected to finally adjust the pH of a whole solution to 3 to 3.5.

(3) Then, tin hydroxide (Sn(OH)₄) was obtained, and all unnecessary ion species were removed using pure water and ethyl alcohol.

(4) Then, the hydrate thus obtained was put in a convection drier and dried at 60° C. for 24 hours.

(5) Dried tin stannate was heated at 200° C. for 2 hours to synthesize tin(IV) oxide having a specific surface area of 168 m²/g.

(6) Hydrophobic coating with dimethyldimethoxysilane, hexamethyldisilazane, or the like was performed with respect to the surface of the tin(IV) oxide nano-size particles obtained in the process of (5) to obtain hydrophobic tin(IV) oxide nano-size particles.

(7) By Blow-Off test with respect to the product obtained in the process of (6), a value of (−) 130 mV was obtained.

(8) According to the conventional method of manufacturing toner, the hydrophobic tin(IV) oxide nano-size particles obtained in the process of (7) and the conventionally used additive such as hydrophobic silica were externally treated at the surface of an image material, toner, and the evaluation results on the physical properties on the toner manufactured showed almost the same level as those when using the conventional titanium(IV) dioxide nano-size particles.

That is, tin(IV) oxide nano-size particles which may replace titanium(IV) dioxide nano-size particles which have harmful controversy to human body, were developed.

2. Synthesis of Complex Tin Oxide Fine Particles and Hydrophobic Coating

(1) 1 mol/L of sodium stannate (Na₂SnO₃) was weighed, 0.01 mol/L of sodium aluminate (NaAlO₂) was weighed, and a sodium stannate (Na₂SnO₃) powder and sodium aluminate were slowly injected to pure water and dissolved well using a stirrer. In this case, the temperature of the pure water was adjusted to about 60° C.

(2) To a mixture solution of the sodium stannate and sodium aluminate, obtained in (1), 1 mol/L of nitric acid (HNO₃) prepared in advance was slowly injected to finally adjust the pH of a whole solution to 3 to 3.5.

(3) Then, an aluminum hydroxide (Al(OH)₃)-tin hydroxide (Sn(OH)₄) complex hydroxide was obtained, and all unnecessary ion species were removed using pure water and ethyl alcohol.

(4) Then, the complex hydrate thus obtained was put in a convection drier and dried at 60° C. for 24 hours.

(5) The dried complex hydroxide of aluminum(III) hydroxide-tin(IV) hydroxide was heated at 300° C. for 2 hours to synthesize aluminum(III) oxide-tin(IV) oxide complex oxide fine particles having a specific surface area of 110 m²/g.

(6) Hydrophobic coating with dimethyldimethoxysilane, hexamethyldisilazane, decyltrimethoxysilane, or the like was performed with respect to the surface of the aluminum(III) oxide-tin(IV) oxide complex oxide nano-size particles obtained in the process of (5) to obtain hydrophobic aluminum(III) oxide-tin(IV) oxide complex oxide nano-size particles.

(7) By Blow-Off test with respect to the product obtained in the process of (6), a value of (−) 140 mV was obtained.

(8) According to the conventional method of manufacturing toner, the hydrophobic aluminum(III) oxide-tin(IV) oxide complex oxide nano-size particles obtained in the process of (7) and the conventionally used additive such as hydrophobic silica were externally treated at the surface of an image material, toner, and the evaluation results on the physical properties on the toner manufactured showed almost the same level as those when using the conventional titanium(IV) dioxide nano-size particles.

That is, aluminum(III) oxide-tin(IV) oxide complex oxide nano-size particles which may replace titanium(IV) dioxide nano-size particles which have harmful controversy to human body, could be obtained.

1. An external additive for toner selected from the group consisting of tin oxide fine particles represented by General Formula of SnaOb (where, “Sn” is tin, “O” is oxygen, and 1.000≤a/b≤2.000 is satisfied), complex tin oxide fine particles represented by General Formula of MxSnyOz (where, M is one or more elements selected from H, an alkali metal, an alkaline earth metal, a rare earth element, Ca, Mg, Sr, Ba, Zr, Ti, Cr, Mn, Fe, Ru, Co, Rh, Ir, Ni, and In, Sn is tin, O is oxygen, 0.001≤x/y≤1 is satisfied, and 1.000≤z/y≤2.000 is satisfied), and a mixture of the fine particles,
wherein the fine particles are (−) charged fine particles having an energy band gap of 3.2 to 3.6 eV, an electronegativity value (χ) of 15 to 18, and a Blow-Off charge amount (uC/g) of −100 to −150.

2. The external additive for toner according to claim 1, wherein a diameter of primary particles of the fine particles is 1 nm or more to 200 nm or less.

3. The external additive for toner according to claim 1, wherein a size of a secondary aggregate that is an aggregate of the primary particles is 10 μm or less.

4. The external additive for toner according to claim 1, wherein a specific surface area of the tin oxide and the complex tin oxide fine particles has a value of 5 to 200 m²/g.

5. The external additive for toner according to claim 1, wherein the fine particles have a composition ratio represented by General Formula of SnaOb (where, “Sn” is tin, “O” is oxygen, and 1.000≤a/b≤2.000 is satisfied).

6. The external additive for toner according to claim 1, wherein the complex tin oxide fine particles represented by General Formula of MxSnyOz has any one or more structures among a tetragonal structure, a cubic structure and a rutile crystalline structure.

7. The external additive for toner according to claim 6, wherein element M is selected from the group consisting of Na, K, Cs, Mg, Ca, Sr, Ba, Fe, Sb, Al, In, Ti, and Zr.

8. An external additive for toner, characterized in that surface of tin oxide fine particles and complex tin oxide fine particles having a size of primary particles of 1 nm to 200 nm is coated with a hydrophobic material showing hydrophobic function.

9. The external additive for toner according to claim 8, wherein the surface of the tin oxide fine particles and the complex tin oxide fine particles are treated and coated with a surface treating agent having the following General Formulae:
(Y)m-Si—(X)n [Si: silicon, (Y+X=4)]
(Y)m-Ti—(X)n, [Ti: titanium, (Y+X=4)]
(Y)m-Zr—(X)n, [Zr: zirconium, (Y+X=4)]
(Y)m-Al—(X)n [Al: aluminum, (Y+Z=3)]
where
Y: an alkyl group, or a phenyl group,
X: an alkoxy group, chloride, bromide, or fluoride.

10. The external additive for toner according to claim 8, wherein the content of the surface treating agent treated at the surface of the tin oxide fine particles and the complex tin oxide fine particles is 0.1 to 50 wt % of the tin oxide fine particles.

11. An external additive for toner, characterized in that surface of toner particles having an average particle diameter of 3 to 8 μm is coated with tin oxide and complex tin oxide fine particles having hydrophobicity within the following range:
Tin oxide/toner particles=0.01 to 1 (weight ratio).

12. The external additive for toner according to claim 2, wherein a size of a secondary aggregate that is an aggregate of the primary particles is 10 μm or less.

13. The external additive for toner according to claim 2, wherein a specific surface area of the tin oxide and the complex tin oxide fine particles has a value of 5 to 200 m²/g.

14. The external additive for toner according to claim 2, wherein the fine particles have a composition ratio represented by General Formula of SnaOb (where, “Sn” is tin, “O” is oxygen, and 1.000≤a/b≤2.000 is satisfied).
